(19) United States
(12) Patent Application Publication
(10) Pub. No.: US 2015/0269422 A1
(43) Pub. Date: Sep. 24, 2015

(54) PERSON REGISTRATION APPARATUS, PERSON RECOGNITION APPARATUS, PERSON REGISTRATION METHOD, AND PERSON RECOGNITION METHOD

(71) Applicant: CANON KABUSHIKI KAISHA, Tokyo (JP)

(72) Inventor: Yuki Wada, Inagi-shi (JP)

(21) Appl. No.: 14/660,743

(22) Filed: Mar. 17, 2015

(30) Foreign Application Priority Data
Mar. 19, 2014 (JP) 2014-056718

(51) Int. Cl. G06K 9/00

(52) U.S. Cl. CPC G06K 9/00295; G06K 9/00261; G06K 9/00268

(57) ABSTRACT

To perform person recognition with high accuracy while suppressing an increase in a data amount and a calculation amount required for processing, a person registration apparatus includes a first registration unit that registers a common feature amount of a predetermined type to a storage unit in association with a new image representing a person to be registered, a calculation unit that calculates a degree of similarity of the common feature amount between the new image and a registered image previously stored in the storage unit, and a second registration unit, in a case where the degree of similarity is greater than or equal to a first threshold, that registers an individual feature amount, which is a different type of the common feature amount, to the storage unit in association with each of the new image and the registered image.

### BACKGROUND

1. Field

Aspects of the present invention generally relate to a person registration apparatus, a person recognition apparatus, a person registration method, and a person recognition method.

2. Description of the Related Art

Conventionally, there has been known a person recognition apparatus that identifies a person in a portrait image by software. The person recognition apparatus determines whether or not a person included in an image to be recognized is a registered person by identifying a face portion in the image to be recognized and by comparing a feature amount of the face portion with a feature amount of a face portion of the registered person registered in dictionary data. Note that information related to the registered person such as face image data of the registered person and a feature amount calculated from the face image data is registered in the dictionary data.

Misrecognition has been a problem in person recognition, and to solve this problem, in Japanese Patent Application Laid-Open No. 2005-063173, there is disclosed a technique of raising (making stricter) a collation threshold for a person to be newly registered in a case where a feature amount of the person to be newly registered is similar to a feature amount of a person already registered.

In general, the feature amount used in the person recognition is often calculated from a part where a difference tends to be apparent between persons such as an eye, a nose, and a mouth, whereby it is possible to recognize the person with higher accuracy as the collation threshold for comparing the feature amount of each of the parts is set stricter or as the number of the parts to be calculated is increased.

However, in a case where a difference of the feature amount is small between the persons, there is a limit in making the collation threshold stricter as in Japanese Patent Application Laid-Open No. 2005-063173, whereby improving the accuracy is not always possible. In a case where the number of the parts is increased, there is a problem in that a data amount of the dictionary data is increased as well as a processing amount is increased, whereby it takes time for calculation.

### SUMMARY

According to an aspect of the present invention, a person registration apparatus includes a first registration unit that registers a common feature amount of a predetermined type to a storage unit in association with a new image representing a person to be registered, a calculation unit that calculates a degree of similarity of the common feature amount between the new image and a registered image previously stored in the storage unit, and a second registration unit that, in a case where the degree of similarity is greater than or equal to a first threshold, registers an individual feature amount, which is a different type of the common feature amount, to the storage unit in association with each of the new image and the registered image.

Further features of the present disclosure will become apparent from the following description of exemplary embodiments (with reference to the attached drawings).

### BRIEF DESCRIPTION OF THE DRAWINGS

FIG. 1 is a view illustrating an information processing device.

FIG. 2 is a view illustrating a data configuration of a secondary storage device.

FIG. 3 is a flowchart illustrating person registration processing.

FIG. 4 is a view illustrating a registration screen.

FIG. 5 is a view illustrating an individual feature amount selection screen.

FIG. 6 is a view for describing the person registration processing.

FIG. 7 is a view illustrating the registration screen.

FIG. 8 is a view illustrating a representation selection screen.

FIG. 9 is a flowchart illustrating person recognition processing.

FIG. 10 is a view illustrating one example of an image to be recognized.

FIG. 11 is a flowchart illustrating registration notification processing.

FIG. 12 is a view illustrating a registration notification screen.

### DESCRIPTION OF THE EMBODIMENTS

Exemplary embodiments will be described in detail with reference to the drawings, by way of example. Components in the exemplary embodiments are described merely as examples, and are not intended to be limiting.

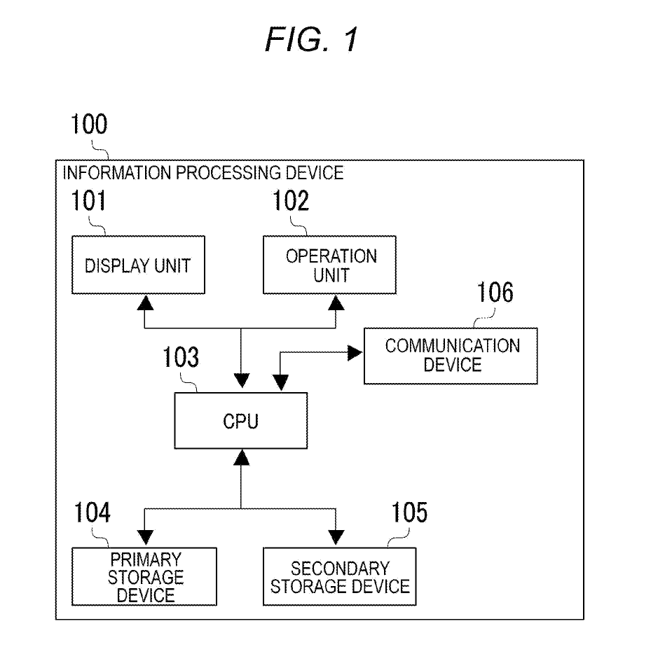

FIG. 1 is a view illustrating an information processing device according to an exemplary embodiment. An information processing device 100 is one example of a person recognition apparatus and a person registration apparatus. The information processing device 100 stores dictionary data of a person who has been registered (hereinafter, referred to as a “registered person”), and through comparison with the dictionary data, performs person recognition on a person in an image for identifying the person. The information processing device 100 is further capable of registering dictionary data of a new person any time. Here, the dictionary data includes information such as a face image of the person and a feature amount of the face image. Details of the dictionary data are described below. The information processing device 100, as illustrated in FIG. 1, has a display unit 101, an operation unit 102, a CPU 103, a primary storage device 104, a secondary storage device 105, and a communication device 106. The display unit 101 performs display of an image, display of characters for interactive operation, and the like. The display unit 101 displays registered content, content input by a user, and the like during registration of the dictionary data. The display unit 101 is, specifically, a display device such as an LCD, for example. It is not necessary that the display unit 101 be provided in the information processing device 100 as long as the information processing device 100 has a display control function for controlling the display on the display unit 101. In this case, the information processing device 100 displays a variety of information on an external display device. The operation unit 102 receives operation by the user. The operation unit 102 is a keyboard, a mouse, and the like. The operation unit 102 is used by the user, for example, for inputting a person name in the dictionary data.

The CPU 103 performs a variety of calculation and control of each of portions constituting the information processing device 100 following a signal that has been input and a program. The primary storage device 104 stores temporary data, which is used in operation of the CPU 103. The secondary storage device 105 stores the program for controlling the information processing device 100, a variety of setting information, and the like.

Note that a function and processing of the information processing device 100 described below is realized by the CPU 103 by reading the program stored in the secondary storage device 105 and the like and by executing the program.

The communication device 106 is connected with an external device and performs transmission and reception of a control command and data. As a protocol for establishing connection and performing data communication, for example, a picture transfer protocol (PTP) and a media transfer protocol (MTP) are used. Note that the communication device 106 may perform the communication through, for example, a wired connection such as a universal serial bus (USB) cable. The communication device 106 may perform the communication also through a wireless connection such as a wireless LAN. The communication device 106 may also be directly connected with the external device or may be connected with the external device through a server or a network such as the Internet.

Note that in this exemplary embodiment, the information processing device is taken as one example of the person recognition apparatus and the person registration apparatus in descriptions. However, it is not to be limited to this, and it may also be an imaging device such as a digital camera as another example.

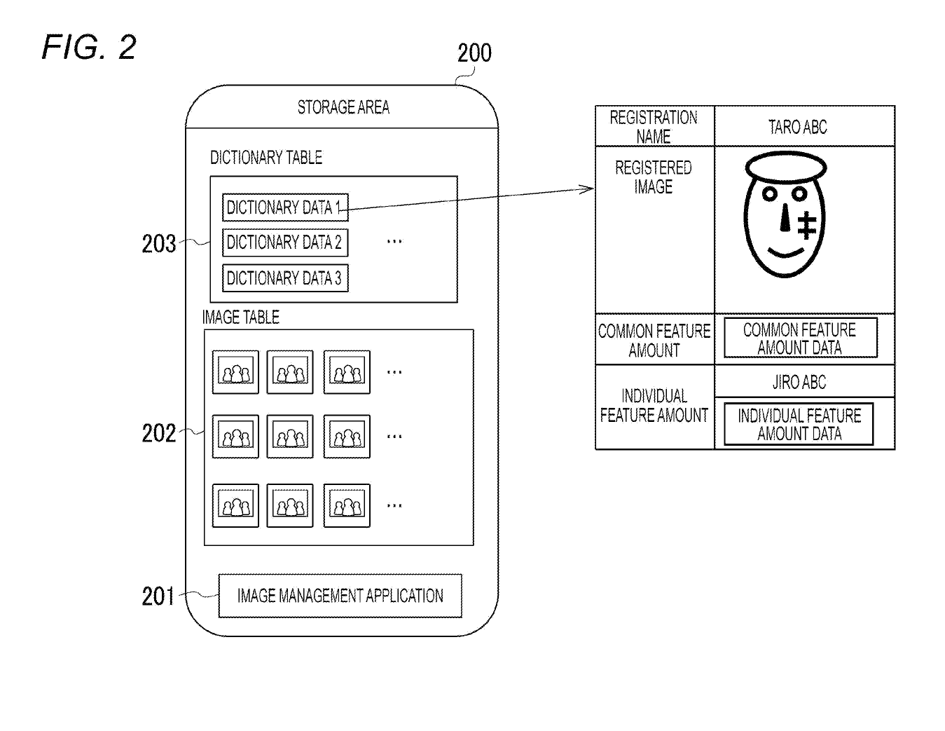

FIG. 2 is a view illustrating a data configuration of the secondary storage device 105. In a storage area 200 of the secondary storage device 105, an image management application 201, an image table 202, and a dictionary table 203 are stored. The image management application 201 is an application for executing processing related to image management. In the image table 202, a plurality of images in which a person is an object is stored.

In the dictionary table 203, a plurality of dictionary data is stored. Each of the dictionary data includes a registration name, a registered image, a common feature amount, and an individual feature amount. The dictionary data further includes a similar person name in association with the individual feature amount. The registration name is a name of the registered person. The registration name is also used as identification information for identifying each of the dictionary data. Note that as another example, the dictionary data may also include the identification information other than the registration name for identifying the dictionary data. The registered image is the face image of the registered person. The registered image is a whole image or a partial image extracted from an image. The feature amount is a feature amount of the face image, and includes a feature amount of each of parts such as an eye, a nose, and a mouth as well as a feature amount of a color of skin, a color of hair, presence of glasses, and the like. The information processing device 100 of this exemplary embodiment manages the feature amount by roughly dividing it into the common feature amount and the individual feature amount according to a type of the feature amount.

The common feature amount is a predetermined feature amount that is registered in the dictionary data of all of the registered persons. The common feature amount is, for example, a combination of the feature amounts calculated from areas of the parts in the person's face such as an eye, a nose, and a mouth. Note that it is preferred that the combination of the feature amounts included in the common feature amount and a type thereof be one capable of accurately recognizing many persons; however, the combination of the feature amounts included in the common feature amount and the type of the common feature amount is not to be limited to those in the exemplary embodiment in this specifications.

The individual feature amount is a feature amount other than the type determined as the common feature amount. The individual feature amount is, for example, a feature amount such as a position of a mole and a scar, a color of skin and hair, and it may not be suitable for recognizing each of the many persons as distinguished but is effective for distinguishing a specific person from other persons. The individual feature amount is a feature amount used for distinguishing each of the similar registered persons as a different person in a case where the common feature amount of two or more registered persons is similar. That is, it is preferred that the individual feature amount be of a type in which the feature amount is different at a degree that makes the similar registered persons distinguishable; however, a specific type of the individual feature amount is not limited to that in this exemplary embodiment.

The similar person name is the registration name of a similar person. Here, the similar person is a person similar to the registered person identified by the registration name in the dictionary data. Specifically, the similar person is a person difficult to be recognized as distinguished from the registered person in terms of the common feature amount; that is, it is another registered person where a degree of similarity between the common feature amount thereof and the common feature amount of the registered person is equal to or less than a threshold. Note that in the dictionary table 203, there is also registered the dictionary data in which the similar person is the registered person. Hereinafter, the registered image registered in the dictionary data of the similar person (registered person) is referred to as a similar image. In this way, the similar image is associated with the registered image through the similar person name.

Note that in a case where the registered person is uniquely recognizable only by the common feature amount of the registered image, the individual feature amount and the similar image are not included in the dictionary data of this registered person. On the other hand, in a case where there is more than one registered person having a similar common feature amount, a plurality of individual feature amounts is included in the dictionary data of one registered person for recognizing the person as distinguished from each of the similar persons.

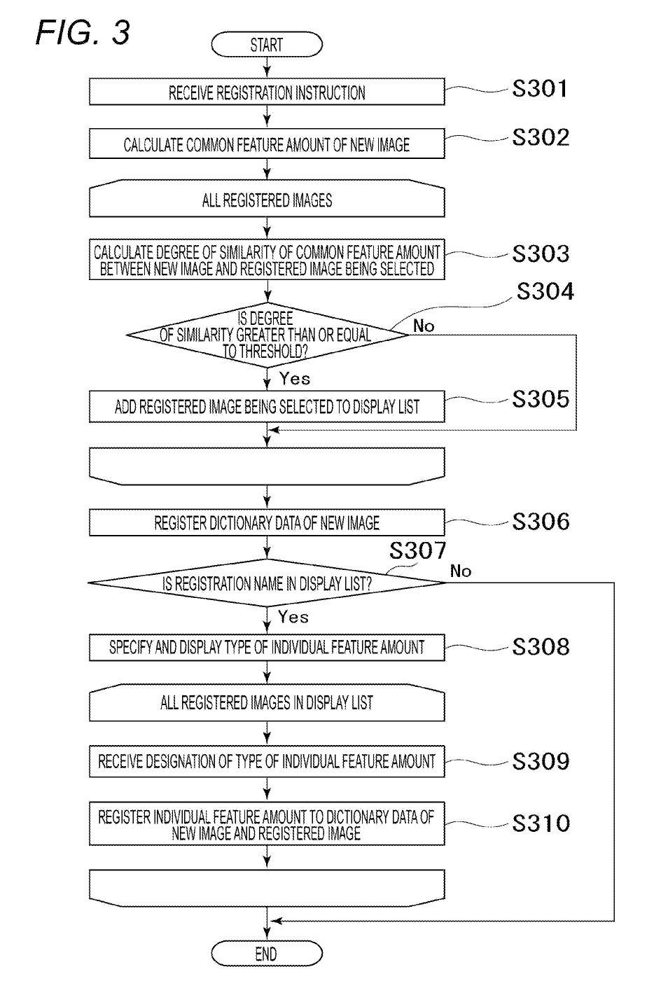

FIG. 3 is a flowchart illustrating person registration processing by the information processing device 100. In the person registration processing, the information processing device 100 registers the dictionary data of the new person following an instruction from the user. In 5301, the CPU 103 receives a registration instruction input by the user. Upon receiving the registration instruction, the CPU 103 cuts out a portrait image from an image to be registered. Specifically, the CPU 103 cuts out the portrait image following a predetermined rule. Note that as another example, the CPU 103 may also display the image to be registered on the display unit 101, may receive designation of an area of the portrait image, and may cut out the portrait image by following the designation.

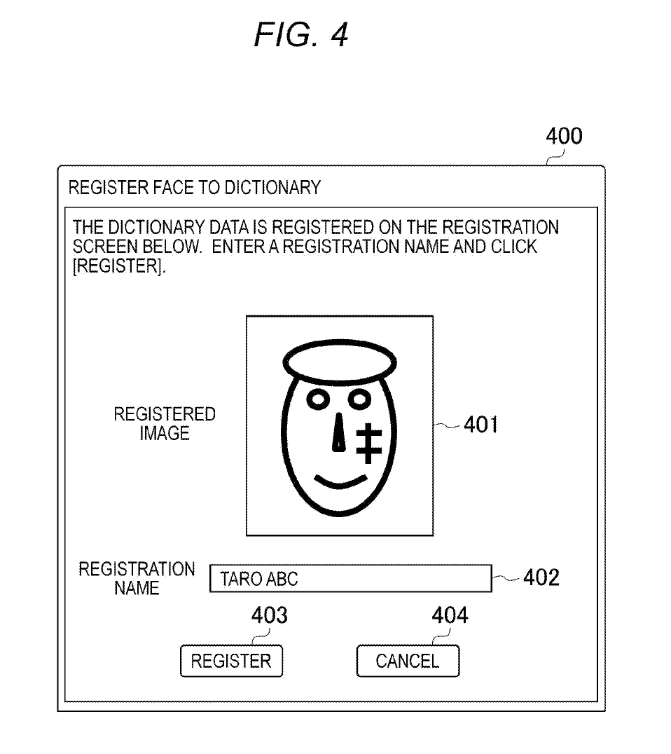

Once the portrait image is cut out, the CPU 103 displays a registration screen 400 illustrated in FIG. 4 on the display unit 101. On the registration screen 400, a cut-out image, or a new image 401 to be registered, is displayed. On the registration screen 400, a registration name entry field 402, a registration button 403, and a cancel button 404 are also displayed. When the user inputs the registration name in the registration name entry field 402 and selects the registration button 403, the CPU 103 receives new registration. On the other hand, when the cancel button 404 is selected by the user, the CPU 103 ends the person registration processing.

Back to FIG. 3, in S302, the CPU 103 calculates the common feature amount of a new image. Next, in S303, the CPU 103 selects one dictionary data from the dictionary table 203 and selects the registered image included in this dictionary data. Then, the CPU 103 calculates the degree of similarity of the common feature amount between the registered image being selected and the new image. Note that a known technique may be used in processing of calculating the degree of similarity. Here, the processing in S303 is one example of calculation processing.

Next, in S304, the CPU 103 compares the degree of similarity of the common feature amount with the threshold. Here, the threshold is set in the secondary storage device 105 in advance. In a case where the degree of similarity of the common feature amount is equal to or greater than the threshold, or in a case where the new image is similar to the registered image in terms of the common feature amount (yes in S304), the CPU 103 advances the processing to S305. In S305, the CPU 103 adds the person name of the registered image being selected to a display list. Here, the display list is stored in the primary storage device 104. Hereinafter, the registered person and the registered image that are identified by the registration name existing in the display list are respectively referred to as the similar person and the similar image of the new person.

In S304, in a case where the degree of similarity of the common feature amount is less than the threshold (no in S304), the CPU 103 checks existence of an unselected registered image in the dictionary table 203. In a case where the unselected registered image exists, the CPU 103 selects the unselected registered image and repeats the processing from S303 to S305 on the registered image that has been selected. In a case where the processing from S303 to S305 is completed on all of the registered images, the CPU 103 ends the loop processing from S303 to S305 and advances the processing to S306.

In S306, the CPU 103 newly registers the dictionary data of the new image. Specifically, the CPU 103 newly creates the dictionary data of the person to be registered. Then, the CPU 103 registers the registration name and the new image that have been input in the registration name entry field 402 respectively to the registration name and the registered image of the created dictionary data. Furthermore, the CPU 103 registers the common feature amount of the new image calculated in S302 to the common feature amount of the dictionary data. Here, the processing in S306 is one example of registration processing. Note that at this point, registration of the individual feature amount and the similar image is not performed yet.

Next, in S307, the CPU 103 checks whether or not the registration name exists in the display list. In a case where the registration name exists therein (yes in S307), the CPU 103 advances the processing to S309. In a case where the registration name does not exist therein (no in S307), the CPU 103 ends the person registration processing.

Note that the case where the registration name does not exist in the display list means a case where the registered person who is not distinguishable in terms of the common feature amount, or the similar person who is similar to the new person, does not exist. In this case, the CPU 103 ends the person registration processing without registering the individual feature amount. In this way, in the case where the similar person does not exist, the individual feature amount is not stored in the dictionary data of the new person. It is because recognition of the new person can be performed by the common feature amount only.

On the other hand, the case where the registration name exists in the display list means a case where the registered person who is difficult to be recognized as distinguished from the new person in terms of the common feature amount, or the similar person, exists. In this case, the individual feature amount used for recognizing the new person as distinguished from the similar person is registered in the processing in S308 and after.

In S308, the CPU 103 specifies the type of the individual feature amount capable of distinguishing the new person from the similar person. Specifically, the CPU 103 specifies the type of the individual feature amount in which the degree of similarity of the individual feature amount between the new image and the similar image is less than the threshold. Here, the threshold is set in advance. Note that the threshold referenced in S308 may be the same value or a different value as the threshold referenced in S304.

For example, in a case where there is a scar only on a cheek of the new person, the degree of similarity is calculated to be less than the threshold for the individual feature amount of the cheek, whereby the CPU 103 specifies a cheek part as the type of the individual feature amount.

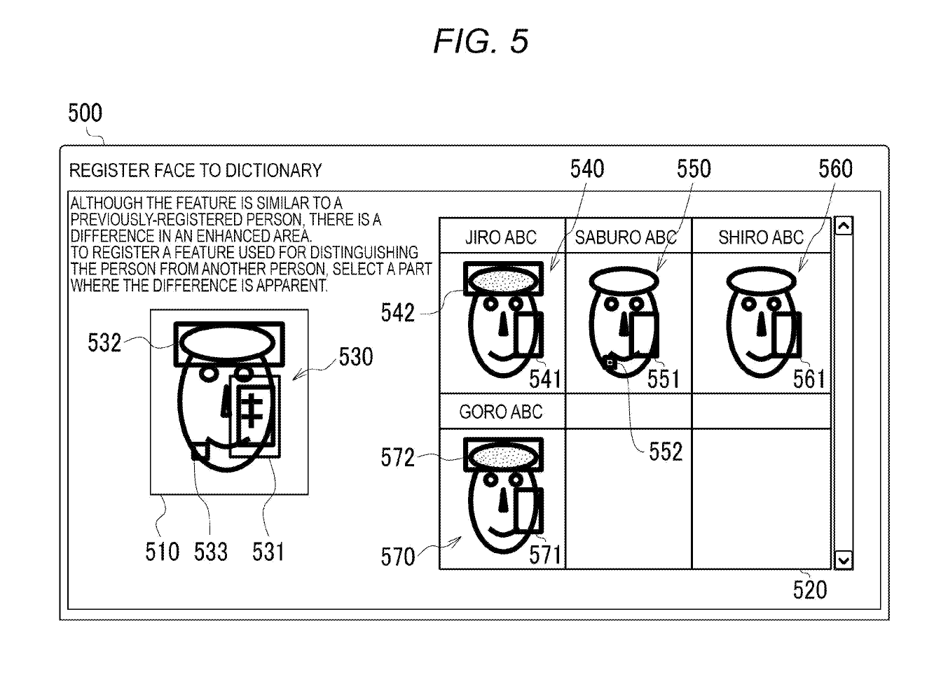

Furthermore, in a case where a plurality of registration names is stored in the display list, or in a case where a plurality of similar persons exists, the CPU 103 specifies the type of the individual feature amount capable of distinguishing each of the similar persons and the new person. Then, the CPU 103 displays the type of the individual feature amount that has been specified on the display unit 101. FIG. 5 is a view illustrating an individual feature amount selection screen displayed in S308. A new image 530 is displayed in a new image display field 510 of an individual feature amount selection screen 500. In a similar image display field 520, the similar image similar to the new image is displayed. Furthermore, for each of the new image and the similar image, a frame indicating the type of the individual feature amount that has been specified is displayed.

For example, in the new image 530 and a similar image 540, in a case where the degree of similarity that is less than the threshold is calculated for the individual feature amount of the cheek corresponding to existence of a scar on a cheek, and the cheek part is specified as the type of the individual feature amount, each of frames 531 and 541 is displayed on the cheek in each of the new image 530 and the similar image 540. Note that each of the frames 531 and 541 indicates the type of the individual feature amount. Furthermore, a color of hair is different between the new image 530 and the similar image 540, whereby a head portion is specified as the type of the individual feature amount, and correspondingly, each of frames 532 and 542 is displayed therein.

Similarly, a similar image 550 is different from the new image 530 in terms of existence of a scar on a cheek and existence of a mole near a mouth, and correspondingly, frames 551 and 552 are displayed therein. Also, a frame 533 corresponding to the mouth is displayed in the new image 530. Similarly, in similar images 560 and 570 as well, frames 561, 571, and 572 indicating the type of the individual feature amount are displayed.

There is a case in which the type of the individual feature amount common to a plurality of similar images is specified among the types of the individual feature amount specified in the new image 530. For example, in an example illustrated in FIG. 5, the type of the individual feature amount of the cheek part is specified common to the plurality of similar images. In this way, in the case where a common type of the individual feature amount is specified, the CPU 103 displays the common type of the individual feature amount in an enhanced way, which is a display manner different from that of the other type of the individual feature amount. Specifically, the CPU 103 displays a frame corresponding to the common type of the individual feature amount with a double line and any other frames with a single line. In a case where more than one common type of the individual feature amount is specified, among them, the CPU 103 displays only the frame indicating the type of the individual feature amount having the largest number of common similar images with the double line.

In the example illustrated in FIG. 5, among the frames 531 to 533, it is possible to recognize the new image 530 as distinguished from all of the similar images 540 to 570 by the cheek part indicated by the frame 531, whereby the number of distinguishable similar persons becomes the largest. Therefore, the CPU 103 displays the frame 531 with the double line.

Note that a specific display manner for displaying the common type of the individual feature amount in the enhanced way is not to be limited to the exemplary embodiment in this specifications. As another example, the CPU 103 may also display the frame to be displayed in the enhanced way with a different color or a different shape from other frames. Here, the processing in S308 is one example of specification processing for specifying the type of the individual feature amount as well as display processing for displaying the type.

The user can designate the type of the individual feature amount of the new image in the individual feature amount selection screen 500. In the example illustrated in FIG. 5, it is possible to designate three types of the individual feature amount indicated by the frames 531, 532, and 533. When the type of the individual feature amount is designated by the user, in S309 in FIG. 3, the CPU 103 receives designation of the type of the individual feature amount. Here, the processing in S309 is one example of receiving processing.

Next, in S310, the CPU 103 registers a value of the individual feature amount of the type of the individual feature amount that has been designated to the individual feature amount of the dictionary data of each of the new image and the similar image, which is distinguishable by the designated individual feature amount. The CPU 103 repeats the processing in S309 and S310 until the individual feature amount is registered for all of the similar images included in the display list.

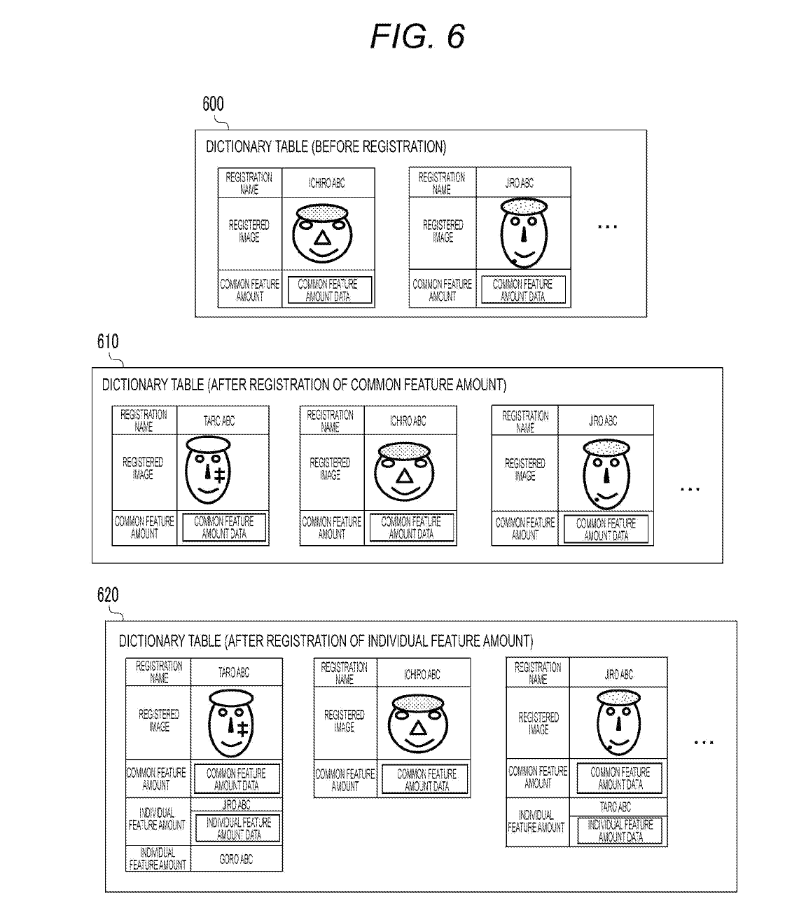

Next, with reference to FIG. 6, the person registration processing is specifically described taking an example of registering dictionary data of a new person under a registration name of “Taro ABC”. In an upper part of FIG. 6, a dictionary table 600 before registration is illustrated. In a middle part of FIG. 6, a dictionary table 610 after the processing in S306 is illustrated. In the dictionary table 610, the dictionary data with the registration name of “Taro ABC” is newly created, and the registration name, the registered image, and the common feature amount are registered in the dictionary data.

In a lower part of FIG. 6, a dictionary table 620 after the person registration processing is illustrated. The dictionary table 620 corresponds to a case where the head portion, or the frame 532, is selected as the type of the individual feature amount in the individual feature amount selection screen 500 illustrated in FIG. 5. It is possible to recognize the registered persons corresponding to the new image 530 and the similar images 540 and 570 as distinguished in terms of the individual feature amount of the head portion indicated by the frame 532.

Correspondingly, as illustrated in the dictionary table 620, the CPU 103 additionally registers the individual feature amount of the head portion and the similar person name “Jiro ABC” corresponding to the similar image 540 to the dictionary data of the new person “Taro ABC” in the dictionary table 610. Furthermore, the CPU 103 additionally registers the individual feature amount of the head portion and the similar person name “Taro ABC” corresponding to the new image to the dictionary data of the “Jiro ABC”.

Furthermore, the CPU 103 additionally registers the individual feature amount of the head portion and a similar person name “Coro ABC” corresponding to the similar image 570 to the dictionary data of “Taro ABC”. Then, the CPU 103 additionally registers the individual feature amount of the head portion and the similar person name “Taro ABC” corresponding to the new image to the dictionary data of “Coro ABC”. In this way, two individual feature amounts are registered in the dictionary data of “Taro ABC”.

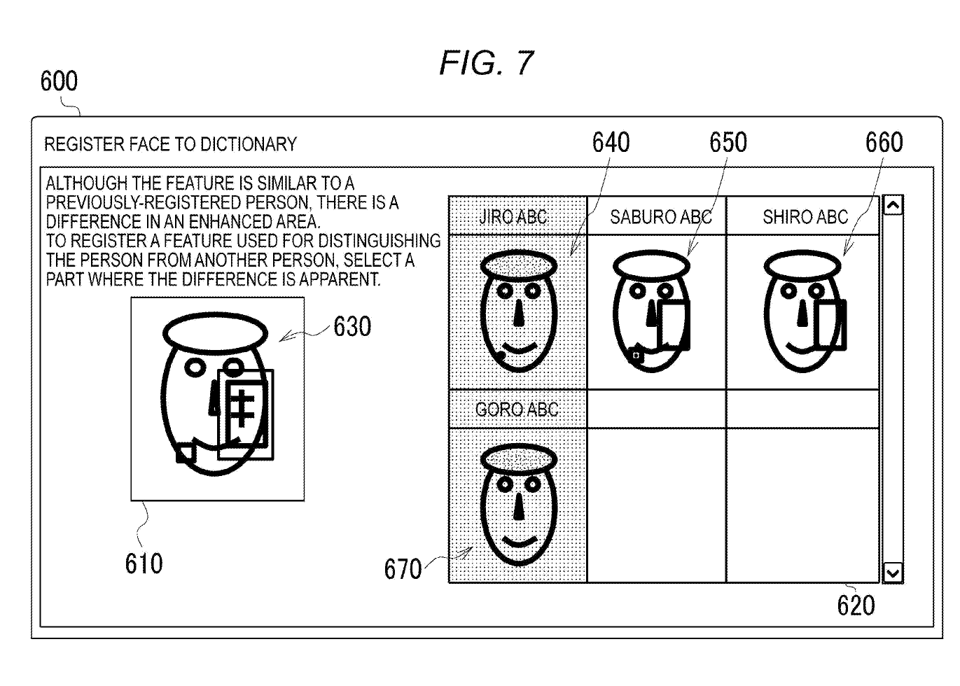

At this time, as illustrated in FIG. 7, the CPU 103 displays the similar image that has become recognizable as distinguished from the new image by the registered individual feature amount in a display manner different from that of the remaining similar image. The CPU 103 may display, for example, only the similar image that has become recognizable as distinguished from the new image in a grayed out manner. Note that at this time, the CPU 103 deletes a frame other than the frame that enables to distinguish between the remaining similar image and the new image. In an example illustrated in FIG. 7, the frame 532 of the new image 530 illustrated in FIG. 5 is deleted.

As above, when registering the dictionary data, the information processing device 100 registers the individual feature amount that enables to recognize the new person as distinguished from the registered person only in a case where it is not possible to recognize these persons as distinguished from each other by the common feature amount only. Accordingly, it is possible to improve accuracy of person recognition. In a case where it is possible to distinguish these persons by the common feature amount only, the information processing device 100 does not register the individual feature amount, whereby it is possible to suppress an increase of a data amount compared to a case where many feature amounts are registered for all of the registered persons.

Furthermore, the information processing device 100 specifies the type of the individual feature amount and registers the individual feature amount according to the designation by the user. Therefore, for example, in a case where the new image to be registered is an image in which the person is wearing a hat where the person usually does not wear, an image in which an insect is flying in front of the person's face, or the like, it is possible to prevent a feature amount representing a feature different from the person's original feature from being registered.

Note that in the person registration processing, it is not necessary for the information processing device 100 to display the individual feature amount and to perform processing of receiving selection made by the user. In this case, the information processing device 100 may specify the individual feature amount and may register the specified individual feature amount to the dictionary data.

As another example, the dictionary data may also include a plurality of registered images per one registered person. In this case, the dictionary data may further include representative identification information indicating which one is the representative image among the plurality of registered images. Here, the representative image is an image used for calculating the common feature amount and the individual feature amount. That is, in the dictionary data in which the representative image is designated and the plurality of registered images is included, the common feature amount and the individual feature amount calculated by using the representative image are stored as the common feature amount and the individual feature amount.

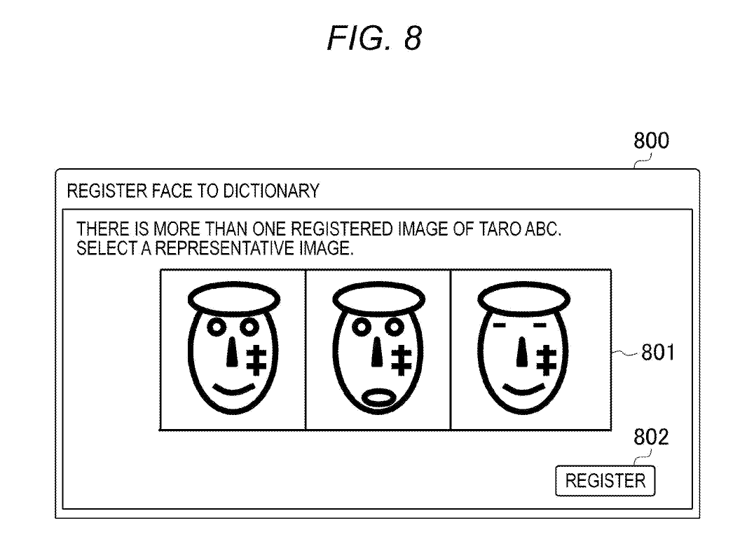

FIG. 8 is a view illustrating a representation selection screen 800. The CPU 103 displays the representation selection screen 800 on the display unit 101, and receives designation of the representative image from the user. In the representation selection screen 800, a registered image display field 801 and a registration button 802 are displayed. In the registered image display field 801, the plurality of registered images registered for one person is displayed.

In the representation selection screen 800, the user selects a registered image to be registered as the representative image and selects the registration button 802, whereby the CPU 103 receives the designation of the representative image. Upon receiving the designation of the representative image, the CPU 103 registers, in the dictionary data, the representative identification information indicating which one is the representative image among the plurality of registered images stored in the dictionary data.

As another example, in a case where the dictionary data includes the plurality of registered images, the dictionary data may store all of the registered common feature amounts and the individual feature amounts. In this case, when calculating the degree of similarity of the common feature amount or the individual feature amount, the CPU 103 may use an average value and the like of the common feature amounts or the individual feature amounts.

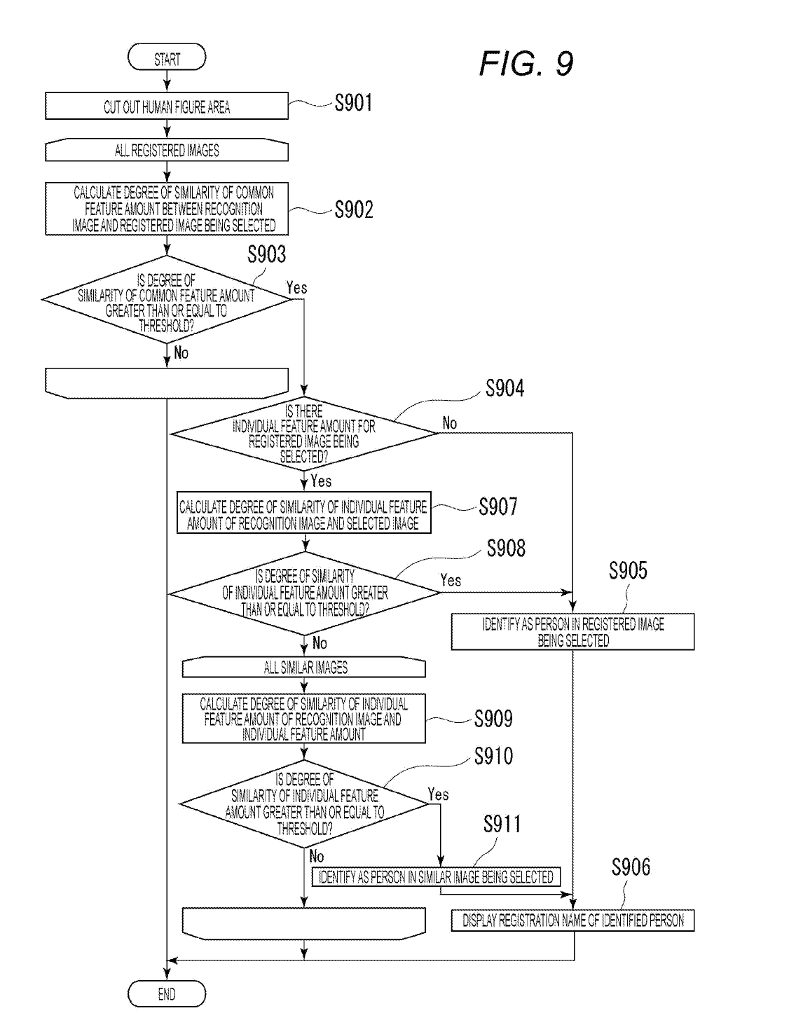

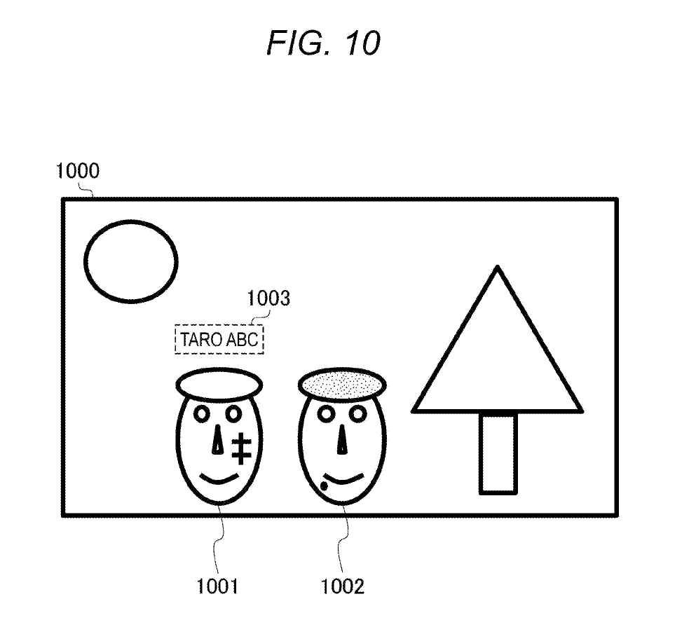

FIG. 9 is a flowchart illustrating person recognition processing by the information processing device 100. The person recognition processing is processing of cutting out a human figure area from an image to be recognized and of displaying a registration name of a person identified in the person recognition. In the person recognition processing, for example, as illustrated in FIG. 10, face images 1001 and 1002 are cut out from an image 1000 to be recognized, and once the registration name of the person is identified in the person recognition, the registration name is displayed as denoted by 1003.

In S901 in FIG. 9, the CPU 103 cuts out the human figure area from an image to be an object of the person recognition. Note that in a case where the plurality of persons is included in the image to be recognized, the CPU 103 cuts out the human figure area as many as the number of the persons. Hereinafter, the human figure area is referred to as a recognition image as the image to be recognized. The CPU 103 further calculates the common feature amount of the recognition image.

Next, in S902, the CPU 103 selects one dictionary data from the dictionary table 203, and selects a registered image included in the selected dictionary data. Then, the CPU 103 calculates the degree of similarity of the common feature amount between the recognition image and the registered image being selected. Here, processing in S902 is one example of the calculation processing. Next, in S903, the CPU 103 compares the degree of similarity of the common feature amount with the threshold. The threshold used in S903 is set in the secondary storage device 105 in advance. Note that the threshold used in S903 may be a different value or the same value as the threshold referenced in S304 in FIG. 3.

In a case where the degree of similarity of the common feature amount is equal to or greater than the threshold (yes in S903), the CPU 103, advances the processing to S904. In a case where the degree of similarity of the common feature amount is less than the threshold (no in S903), the CPU 103 checks whether or not all of the dictionary data stored in the dictionary table 203 have been selected. In a case where unselected dictionary data exists, the CPU 103 advances the processing to S902. In S902, the CPU 103 selects the unselected dictionary data again from the dictionary table 203, selects the registered image included in the dictionary data that has been selected, and continues the loop processing in S902 and S903. In a case where all of the dictionary data have already been selected, the CPU 103 ends the loop processing and further ends the person recognition processing.

In S904, the CPU 103 checks whether or not the individual feature amount is associated with the registered image being selected in the dictionary data. In a case where the individual feature amount is associated with the registered image being selected (yes in S904), the CPU 103 advances the processing to S907. In a case where the individual feature amount is not associated with the registered image being selected (no in S904), the CPU 103 advances the processing to S905.

In S905, the CPU 103 identifies that the person in the recognition image is the registered person corresponding to the registered image being selected. Next, in S906, the CPU 103 displays the registration name associated with the registered image being selected as the person name of the person in the recognition image near the human figure area in the image to be recognized as illustrated in 1003 in FIG. 10, and ends the person recognition processing.

When the individual feature amount does not exist in the dictionary data of the registered image being selected, it means that a similar person who is difficult to be recognized as distinguished by the common feature amount does not exist. Therefore, in a case where a degree of similarity of the common feature amount is equal to or greater than the threshold and the individual feature amount is not stored in this way, the information processing device 100 is capable of identifying that the person in the recognition image is the person in the registered image being selected without referencing the individual feature amount.

On the other hand, when the individual feature amount exists in the dictionary data of the registered image being selected, it means that a registered image similar to the registered image being selected exists in the dictionary table 203. In this case, the information processing device 100 recognizes by distinguishing the person in the recognition image as which person among a plurality of similar registered persons in the processing in S907 and after.

In S907, the CPU 103 calculates the individual feature amount of the recognition image corresponding to the individual feature amount of the registered image being selected. Then, the CPU 103 calculates the degree of similarity of the individual feature amount between the recognition image and the registered image being selected. Next, in S908, the CPU 103 compares the degree of similarity with the threshold. Here, the degree of similarity is set in the secondary storage device 105 in advance. Note that the threshold used in S908 may be a different value or the same value as the threshold used in other processing.

In a case where the degree of similarity of the individual feature amount is equal to or greater than the threshold (yes in S908), the CPU 103 advances the processing to S905. That is, in a case where the degree of similarity of the individual feature amount is equal to or greater than the threshold, the CPU 103 identifies that the person in the recognition image is the registered person corresponding to the registered image being selected. In a case where the degree of similarity of the individual feature amount is less than the threshold (no in S908), the CPU 103 advances the processing to S909.

In S909, the CPU 103 selects one similar image associated with the individual feature amount of the registered image being selected. Then, the CPU 103 calculates the degree of similarity between the individual feature amount of the recognition image and the individual feature amount stored in the dictionary data of the similar image being selected. Next, in S910, the CPU 103 compares the degree of similarity of the individual feature amount with the threshold. Here, the threshold is set in the secondary storage device 105 in advance. Note that the threshold used in S910 may be a different value or the same value as the threshold used in other processing. In a case where the degree of similarity of the individual feature amount is equal to or greater than the threshold (yes in S910), the CPU 103 advances the processing to S911. In S911, the CPU 103 identifies that the person in the recognition image is the registered person corresponding to the similar image being selected, and advances the processing to S906. Here, the processing in S905 and S911 is one example of recognition processing for recognizing whether or not it is the registered person.

In a case where the degree of similarity of the individual feature amount is less than the threshold (no in S910), the CPU 103 checks whether or not all of the similar images associated with the individual feature amount have been selected. In a case where an unselected similar image exists, the CPU 103 advances the processing to S909, selects the unselected similar image, and continues the loop processing in S909 and S910. In a case where all of the similar images have been selected, the CPU 103 ends the loop processing and further ends the person recognition processing. In a case where the person recognition processing is ended without identifying the person in the recognition image, the CPU 103 may display information prompting registration of the dictionary data of the person in the recognition image on the display unit 101.

Next, the person recognition processing is described specifically by taking an example in which a recognition image in which “Jiro ABC” is an object is to be processed and the dictionary table 620 in FIG. 6 is referenced. In this case, in the loop processing in S902 and S903, the CPU 103 selects “Taro ABC”, “Ichiro ABC”, and “Jiro ABC” in order. Then, the CPU 103 determines that the common feature amount is equal to or greater than the threshold with “Taro ABC” (yes in S903) and advances the processing to S904. In this case, since it has exited the loop processing in S902 and S903, selection of “Ichiro ABC” and “Jiro ABC” and comparison of the common feature amount are not performed.

Then, in S904, since the individual feature amount is stored in the dictionary data of “Taro ABC” (yes in S904), the CPU 103 advances the processing to S907. In S907, the CPU 103 calculates the degree of similarity of the individual feature amount of the recognition image and “Taro ABC”. Then, in S908, the CPU 103 compares the degree of similarity of the individual feature amount with the threshold. In this example, the degree of similarity is less than the threshold, whereby the CPU 103 advances the processing to S909.

The CPU 103 acquires the registration name of the similar person “Jiro ABC” from the dictionary data of “Taro ABC”, and specified the dictionary data of “Jiro ABC”. Then, the CPU 103 calculates the degree of similarity between the individual feature amount of the dictionary data of “Jiro ABC” and the individual feature amount of the recognition image and compares it with the threshold. In this example, the degree of similarity is equal to or greater than the threshold, whereby the CPU 103 identifies that the person in the recognition image is “Jiro ABC”.

As above, the information processing device 100 according to this exemplary embodiment first performs the person recognition using the common feature amount, and only in a case where more than one person having a similar common feature amount is registered, performs the person recognition using the individual feature amount.

Accordingly, it is possible to perform the person recognition with high accuracy in a short time.

### Second Exemplary Embodiment

An information processing device 100 according to a second exemplary embodiment, in a case where an image to be an object of person recognition processing includes similar persons such as brothers and twins as illustrated in FIG. 10 and where dictionary data of one of the persons is already registered, prompts registration of dictionary data of an unregistered person.

In a case where the similar persons are included in the image to be an object of person recognition, the information processing device 100 is capable of recognizing by distinguishing each of the two persons when each of the dictionary data is registered. However, only the dictionary data of one of the persons is registered in some cases. In this case, the information processing device 100 may misrecognize each of the two persons as a registered person. Therefore, as described above, the information processing device 100 according to this exemplary embodiment aims at improving accuracy of the person recognition by prompting the registration of the dictionary data of the unregistered person.

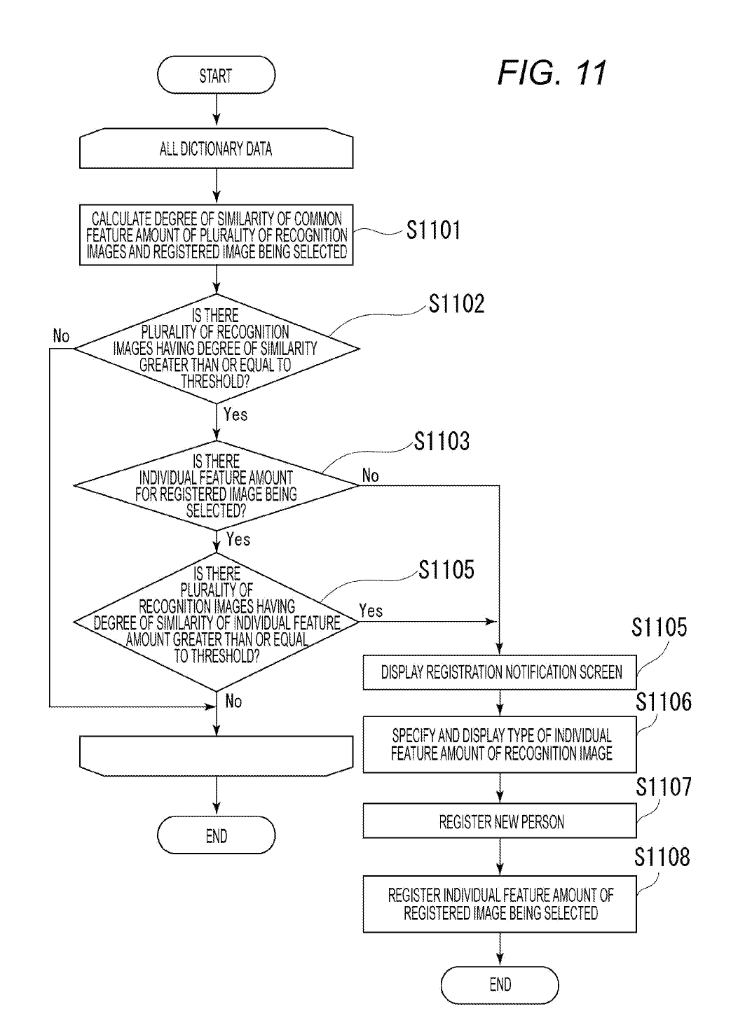

FIG. 11 is a flowchart illustrating registration notification processing. Note that the registration notification processing is executed independently from the person recognition processing in a case where a plurality of human figure areas is cut out in human figure area cut-out processing (S901) in the person recognition processing (FIG. 9). In S1101, a CPU 103 selects one dictionary data from a dictionary table 203 and selects a registered image included in the dictionary data that has been selected. Then, the CPU 103 calculates a degree of similarity of a common feature amount between each of two or more recognition images included in one image to be recognized and the registered image being selected.

Next, in S1102, the CPU 103 compares the degree of similarity of the common feature amount with a threshold. The threshold used in S1102 is set in advance in a secondary storage device 105. Note that the threshold used in S1102 may be a different value or the same value as the threshold referenced in other processing.

In a case where more than one recognition image having the degree of similarity of the common feature amount equal to or greater than the threshold exists in a plurality of recognition images obtained from one image (yes in S1102), the CPU 103 advances processing to S1103. In a case where more than one recognition image having the degree of similarity of the common feature amount equal to or greater than the threshold does not exist in the plurality of recognition images obtained from one image, the CPU 103 checks whether or not all of the dictionary data in the dictionary table 203 have been selected. Then, in a case where all of the dictionary data have been selected, the CPU 103 ends the registration notification processing. Note that all of the dictionary data is selected and the processing is not advanced to S1105 when none of the dictionary data of a person corresponding to the plurality of recognition images obtained from one image is registered. In this way, in a case where none of the dictionary data is registered, the CPU 103 ends the registration notification processing.

On the other hand, in a case where an unselected dictionary data exists, the CPU 103 selects the unselected dictionary data, and continues loop processing in S1101 and after. Here, the case where more than one recognition image having the degree of similarity equal to or greater than the threshold does not exist includes a case where the recognition image having the degree of similarity of the common feature amount equal to or greater than the threshold does not exist and a case where one recognition image having the degree of similarity equal to or greater than the threshold exists.

In S1103, the CPU 103 checks whether or not an individual feature amount is associated with the registered image being selected in the dictionary data. In a case where the individual feature amount is associated with the registered image being selected (yes in S1103), the CPU 103 advances the processing to S1104. In a case where the individual feature amount is not associated with the registered image being selected (no in S1103), the CPU 103 advances the processing to S1105. In S1104, the CPU 103 calculates a degree of similarity of the individual feature amount of each of the plurality of recognition images having the common feature amount equal to or greater than the threshold and the registered image being selected, and compares it with the threshold. The threshold used in S1104 is set to the secondary storage device 105 in advance. Note that the threshold used in S1104 may be a different value or the same value as the threshold referenced in other processing.

In a case where more than one recognition image having the degree of similarity of the individual feature amount equal to or greater than the threshold relative to the registered image being selected exists (yes in S1104), the CPU 103 advances the processing to S1105. In a case where more than one recognition image having the degree of similarity of the individual feature amount equal to or greater than the threshold relative to the registered image being selected does not exist (yes in S1104), the CPU 103 checks whether or not all of the dictionary data in the dictionary table 203 have been selected. Then, when all of the dictionary data have been selected, the CPU 103 ends the registration notification processing, and when an unselected dictionary data exists, it selects the dictionary data and continues the processing in S1101 and after.

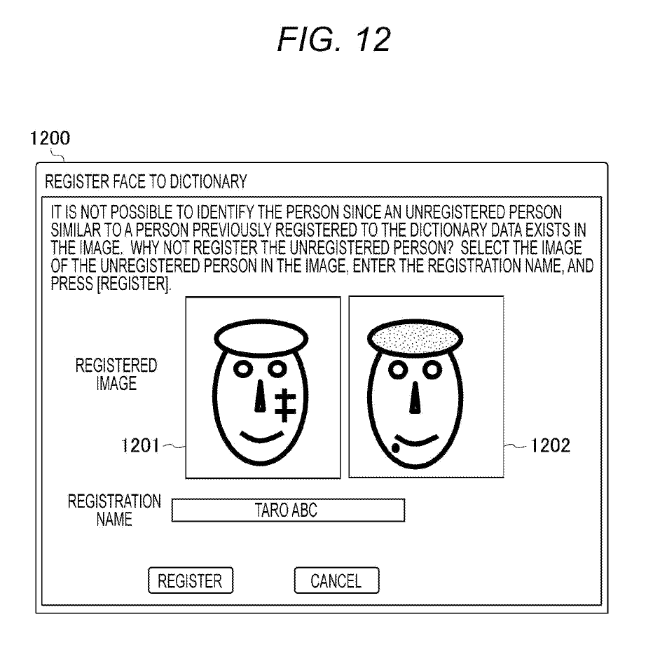

The processing is determined as “no” in S1103 and “yes” in S1104 in a case where an unregistered person exists in the recognition image. Therefore, in this case, in S1105, the CPU 103 displays a registration notification screen prompting registration of the unregistered person on a display unit 101. FIG. 12 is a view illustrating a registration notification screen 1200. Content prompting the registration is displayed on the registration notification screen 1200. Here, the registration notification screen 1200 is one example of a registration notification. The processing in S1105 is one example of output processing of outputting the registration notification on the display unit 101.

On the registration notification screen 1200, other than the content prompting the registration, the plurality of recognition images obtained from the image to be recognized, or face images 1201 and 1202, is displayed. A user can select the face image of the unregistered person on the registration notification screen 1200 and input a registration name. When input is performed by the user on the registration notification screen 1200, the CPU 103 generates the dictionary data of the unregistered person following content input to the registration notification screen 1200 and additionally registers it in the dictionary table 203 in the processing in S1106 and after.

That is, in S1106, the CPU 103 sets the recognition image selected by the user as a new image to be registered, specifies a type of the individual feature amount capable of distinguishing a new image from the registered image being selected, and displays it. Note that the processing in S1106 is similar to the processing in S308 illustrated in the person registration processing (FIG. 3).

Next, in S1107, the CPU 103 newly creates the dictionary data of a new person, and registers the registration name input on the registration notification screen 1200 and the portrait image selected thereon respectively to the registration name and the registered image of the dictionary data. Furthermore, the CPU 103 registers the common feature amount of the new image to the common feature amount of the dictionary data. Next, in S1108, the CPU 103 registers a value of the individual feature amount of the type of the individual feature amount designated by the user to the individual feature amount of the dictionary data of each of the new image and the registered image being selected, and ends the registration notification processing.

As above, the information processing device 100 according to the second exemplary embodiment, in a case where it is not possible to identify the person since the similar persons are included in one image, determines that an unregistered person is included and prompts the registration of the unregistered person. Accordingly, the information processing device 100 is capable of improving recognition accuracy.

Note that any other configuration and processing of the information processing device 100 according to the second exemplary embodiment is similar to the configuration and processing of the information processing device 100 according to the first exemplary embodiment.

### OTHER EXEMPLARY EMBODIMENTS

According to each of the above-described exemplary embodiments, it is possible to perform the person recognition with high accuracy while suppressing an increase in the data amount and the calculation amount required for the processing.

### OTHER EMBODIMENTS

Additional exemplary embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2014-056718, filed Mar. 19, 2014, which is hereby incorporated by reference herein in its entirety.

What is claimed is:

1. A person registration apparatus configured to register a feature amount of a person in association with data of the person stored in a storage unit, the person registration apparatus comprising:
a first registration unit configured to register a common feature amount of a predetermined type to the storage unit in association with a new image representing the person to be registered;
a calculation unit configured to calculate a degree of similarity of the common feature amount between the new image and a registered image previously stored in the storage unit; and
a second registration unit configured to, in a case where the degree of similarity is greater than or equal to a first threshold, register an individual feature amount, which is a different type of the common feature amount, to the storage unit in association with each of the new image and the registered image.

2. The person registration apparatus according to claim 1, further comprising:
a specification unit configured to specify a type of the individual feature amount with which a degree of similarity of the individual feature amount between the new image and the registered image is less than a second threshold in a case where the degree of similarity is greater than or equal to the first threshold, wherein
the second registration unit registers the individual feature amount of the type specified by the specification unit.

3. The person registration apparatus according to claim 2, further comprising:
a displaying unit configured to display the type specified by the specification unit; and
a receiving unit configured to receive designation of the type to be registered relative to the type displayed by the displaying unit, wherein
the second registration unit registers the individual feature amount of the designated type to the storage unit.

4. The person registration apparatus according to claim 3, wherein
the displaying unit, in a case where a plurality of types is specified, displays the plurality of the types that have been specified.

5. The person registration apparatus according to claim 3, wherein
the displaying unit, in a case where the degree of similarity greater than or equal to the first threshold is calculated between the new image and each of a plurality of registered images and where the type is specified for each of the plurality of registered images, displays the type for each of the plurality of registered images.

6. The person registration apparatus according to claim 5, wherein
the displaying unit, in a case where the type that is common to different registered images is specified, displays the type that is common in a display manner different from another type.

7. The person registration apparatus according to claim 6, wherein
the displaying unit, in a case where more than one type that is common is specified, displays the type having the largest number of the registered images of the type that is common in a display manner different from the other type.

8. A person recognition apparatus configured to perform person recognition, the person recognition apparatus comprising:
a storage unit configured to store an individual feature amount together with a common feature amount of a predetermined type in association with each of a plurality of registered images representing a registered person previously registered, wherein the individual feature amount is a different type of the common feature amount in association with each of two or more registered images having a degree of similarity of the common feature amount greater than or equal to a first threshold from among the registered images;
a first calculation unit configured to calculate the degree of similarity of the common feature amount between the registered image stored in the storage unit and a recognition image to be an object of the person recognition;
a second calculation unit configured to calculate a degree of similarity of the individual feature amount between the registered image and the recognition image; and
a person recognition unit configured to recognize, based on the degree of similarity of the common feature amount and the degree of similarity of the individual feature amount, whether a person in the recognition image is the registered person corresponding to the registered image.

9. The person recognition apparatus according to claim 8, wherein
in a case where the degree of similarity of the common feature amount is greater than or equal to the first threshold, the person recognition unit recognizes whether a person to be recognized is the registered person corresponding to the registered image based on the degree of similarity of the individual feature amount.

10. The person recognition apparatus according to claim 9, wherein
the person recognition unit determines, in a case where the degree of similarity of the common feature amount is greater than or equal to the first threshold and the degree of similarity of the individual feature amount is greater than or equal to a second threshold, that the person in the recognition image is the registered person corresponding to the registered image.

11. The person recognition apparatus according to claim 10, wherein
the person recognition unit determines, in a case where the degree of similarity of the common feature amount is greater than or equal to the first threshold and where the degree of similarity of the individual feature amount is less than the second threshold, that the person in the recognition image is not the registered person corresponding to the registered image.

12. The person recognition apparatus according to claim 11, wherein
the storage unit, further stores, in association with the individual feature amount, another registered image, which is different from the registered image associated with the individual feature amount and is distinguishable by the individual feature amount, as a similar image, and
wherein the person recognition unit recognizes, in a case where the degree of similarity of the common feature amount is greater than or equal to the first threshold, where the degree of similarity of the individual feature amount is less than the second threshold, and where the similar image is associated with the registered image, whether the person in the recognition image is the registered person corresponding to the similar image based on the degree of similarity of the individual feature amount between the recognition image and the similar image.

13. The person recognition apparatus according to claim 10, further comprising:
a first registration unit configured to register the common feature amount to the storage unit in association with a new image representing a person to be registered;
a third calculation unit configured to calculate the degree of similarity of the common feature amount between the new image and the registered image; and
a second registration unit configured to, in a case where the degree of similarity calculated by the third calculation unit is greater than or equal to the first threshold, register the individual feature amount to the storage unit in association with each of the new image and the registered image.

14. The person recognition apparatus according to claim 13, further comprising:
an output unit configured to output a registration notification prompting registration of an unregistered person in a case where the degree of similarity of the common feature amount is greater than or equal to the first threshold between two or more recognition images included in one image and the same registered image.

15. The person recognition apparatus according to claim 14, wherein
the output unit outputs, in a case where the degree of similarity of the common feature amount is greater than or equal to the first threshold between the two or more recognition images and the same registered image and where the degree of similarity of the individual feature amount is greater than or equal to the second threshold between the two or more recognition images and the same registered image, the registration notification prompting the registration of the unregistered person.

16. A person registration method executed by a person registration apparatus configured to register a feature amount of a person in association with stored data of the person, the person registration method comprising:
registering a common feature amount of a predetermined type in association with a new image representing the person to be registered;
calculating a degree of similarity of the common feature amount between the new image and a previously registered image; and
registering, in a case where the degree of similarity is greater than or equal to a first threshold, an individual feature amount, which is a different type of the common feature amount, in association with each of the new image and the registered image.

17. A person registration method executed by a person recognition apparatus, the person recognition apparatus including a storage unit configured to store an individual feature amount together with a common feature amount of a predetermined type in association with each of a plurality of registered images representing a registered person, wherein the individual feature amount is a different type of the common feature amount in association with each of two or more registered images having a degree of similarity of the common feature amount greater than or equal to a first threshold from among the registered images, the person registration method comprising:
calculating the degree of similarity of the common feature amount between the registered image stored in the storage unit and the recognition image to be an object of the person recognition;
calculating a degree of similarity of the individual feature amount between the registered image and the recognition image; and
recognizing, based on the degree of similarity of the common feature amount and the degree of similarity of the individual feature amount, whether a person in the recognition image is the registered person corresponding to the registered image.

18. A storage medium storing computer executable instructions that cause a computer to execute a person registration method to register a feature amount of a person in association with stored data of the person, the person registration method comprising:
registering a common feature amount of a predetermined type in association with a new image representing the person to be registered;
calculating a degree of similarity of the common feature amount between the new image and a previously registered image; and
registering, in a case where the degree of similarity is greater than or equal to a first threshold, an individual feature amount, which is a different type of the common feature amount, in association with each of the new image and the registered image.

19. A storage medium storing computer executable instructions that cause a person recognition apparatus to execute a person recognition method, the person recognition apparatus including a storage unit configured to store an individual feature amount together with a common feature amount of a predetermined type in association with each of a plurality of registered images representing a registered person, wherein the individual feature amount is a different type of the common feature amount in association with each of two or more registered images having a degree of similarity of the common feature amount greater than or equal to a first threshold from among the registered images, the person recognition method comprising:
calculating the degree of similarity of the common feature amount between the registered image stored in the storage unit and the recognition image to be an object of the person recognition;
calculating a degree of similarity of the individual feature amount between the registered image and the recognition image; and
recognizing, based on the degree of similarity of the common feature amount and the degree of similarity of the individual feature amount, whether a person in the recognition image is the registered person corresponding to the registered image.
